(19) United States
(12) Patent Application Publication
(10) Pub. No.: US 2026/0302220 A1
(43) Pub. Date: Oct. 1, 2026

(54) POSITIVE ELECTRODE ACTIVE MATERIAL, ELECTRODE, AND BATTERY

(71) Applicant: TOYOTA JIDOSHA KABUSHIKI KAISHA, Toyota-shi (JP)

(72) Inventors: Daiki MAEDA, Toyota-shi (JP); Yuki Ishigaki, Nisshin-shi (JP)

(73) Assignee: TOYOTA JIDOSHA KABUSHIKI KAISHA, Toyota-shi (JP)

(21) Appl. No.: 19/418,664

(22) Filed: Dec. 12, 2025

(30) Foreign Application Priority Data
Jan. 17, 2025 (JP) 2025-006758

(51) Int. Cl. H01M 4/58; C01B 25/45; H01M 4/02

(52) U.S. Cl. CPC H01M 4/5825; C01B 25/45; C01P 2004/50; C01P 2004/61; C01P 2006/14; C01P 2006/40; H01M 2004/021; H01M 2004/028

(57) ABSTRACT

The positive electrode active material includes a plurality of secondary particles. A cross-section of the secondary particles includes a central portion and a peripheral portion. The central portion includes a plurality of first primary particles having a first average particle diameter. The peripheral portion includes a plurality of second primary particles having a second average particle diameter. The first primary particles and the second primary particles include an olivine phosphate compound. A relationship of d2<d1 is satisfied, where d1 indicates the first average particle diameter, and d2 indicates the second average particle diameter.

### CROSS-REFERENCE TO RELATED APPLICATION

This application claims priority to Japanese Patent Application No. 2025-006758 filed on Jan. 17, 2025. The disclosure of the above-identified application, including the specification, drawings, and claims, is incorporated by reference herein in its entirety.

### BACKGROUND

### 1. Technical Field

The present disclosure relates to a positive electrode active material, an electrode, and a battery.

### 2. Description of Related Art

Japanese Unexamined Patent Application Publication No. 2019-40854 (JP 2019-40854 A) discloses a lithium iron manganese phosphate-based particle including a core portion and a shell portion. The core portion contains lithium iron manganese phosphate-based nanoparticles having a first average particle diameter. The shell portion contains lithium iron manganese phosphate-based nanoparticles having a second average particle diameter larger than the first average particle diameter.

### SUMMARY

An olivine phosphate compound has been studied as a positive electrode active material. In a case where the size of primary particles of the olivine phosphate compound is reduced, the rate characteristic is improved, but the energy density may be reduced. There is room for improvement in achieving a balance between the energy density and the rate characteristic (for example, a discharge capacity and high-current discharge performance).

An object of the present disclosure is to improve the rate characteristic while the energy density is maintained.

Hereinafter, technical configurations and effects of the present disclosure will be described. Note that mechanism of action of the present disclosure includes an assumption. Whether the mechanism of action is right or wrong does not limit the scope of the claims.

### Aspect 1

A positive electrode active material including a plurality of secondary particles, in which
a cross-section of each of the secondary particles includes a central portion and a peripheral portion,
the central portion includes a plurality of first primary particles having a first average particle diameter,
the peripheral portion includes a plurality of second primary particles having a second average particle diameter,
the first primary particles and the second primary particles contain an olivine phosphate compound,
a relationship of d2<d1 is satisfied,
d1 indicates the first average particle diameter, and
d2 indicates the second average particle diameter.

In a high-density electrode or a thick film electrode, it is more difficult to secure a movement path of lithium (Li) ions to the inside of the electrode, and Li ion supply in an electrode thickness direction and a particle radius direction is insufficient, which may lead to a decrease in performance. In particular, in a case where a positive electrode active material having a large particle size is applied to a thick film electrode, the movement distance of the Li ions is longer, so that the difficulty in securing the movement path is more remarkable. In a case where sizes of the primary particles are reduced, diffusibility of the Li ions is improved, but a fine pore volume in the secondary particles increases, which may reduce an energy density. With the configuration of Aspect 1, by disposing particles having a large average particle diameter in the central portion of the secondary particle and disposing particles having a small average particle diameter in the peripheral portion, it is expected to improve the rate characteristic while the energy density is maintained.

### Aspect 2

The positive electrode active material according to Aspect 1, in which a relationship of d 2≤50 nm and 100 nm≤d1 is satisfied.

### Aspect 3

The positive electrode active material according to Aspect 1 or 2, in which
D50 of the secondary particles is 5 μm or more, and
a fine pore volume of the secondary particles is 0.10 cm³/g or more and 0.15 cm³/g or less.

### Aspect 4

An electrode including
a positive electrode layer, in which
the positive electrode layer contains the positive electrode active material according to any one of Aspects 1 to 3, and
a basis weight of the positive electrode layer is 28 mg/cm² or more.

### Aspect 5

A battery including the electrode according to Aspect 4.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a conceptual diagram showing secondary particles in the present embodiment;

FIG. 2 is a schematic flowchart showing a manufacturing method of a positive electrode active material in the present embodiment;

FIG. 3 is a schematic perspective view of a battery in the present embodiment;

FIG. 4 is a schematic cross-sectional view taken along line IV-IV in FIG. 3; and

FIG. 5 is a table showing experimental results.

### DETAILED DESCRIPTION OF EMBODIMENTS

Hereinafter, embodiments of the present disclosure (which may be abbreviated as “the present embodiments” below) and examples of the present disclosure (which may be abbreviated as “the present examples” below) will be described. However, the present embodiments and the present examples do not limit the technical scope of the present disclosure.

### Positive Electrode Active Material

The positive electrode active material in the present embodiment includes a plurality of secondary particles 2. The positive electrode active material may be an aggregate of the secondary particles 2. That is, the positive electrode active material may be a powder. The D50 of the positive electrode active material may be, for example, 5 μm or more, 10 μm or more, 15 μm or more, or 20 μm or more. The D50 of the positive electrode active material may be, for example, 50 μm or less, 45 μm or less, 40 μm or less, 35 μm or less, 30 μm or less, or 25 μm or less. The “D50” indicates a particle diameter at which an integrated value is 50% in a volume-based particle size distribution (cumulative distribution). D50 can be measured with a laser diffraction particle size distribution measuring apparatus.

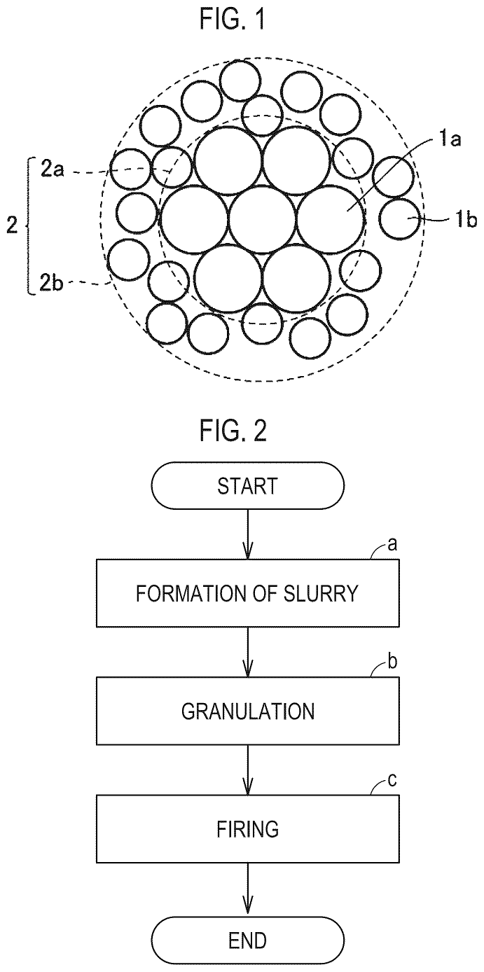

FIG. 1 is a conceptual diagram showing secondary particles in the present embodiment. A minimum circumscribing circle is fitted to the secondary particles 2. A radius of the minimum circumscribing circle is D. That is, a diameter of the minimum circumscribing circle is 2D. A circular portion including the center of the minimum circumscribing circle and having a radius of less than D is regarded as a “central portion 2a”. A radius of the central portion 2a may be, for example, 0.5D. In a cross-section of the secondary particles 2, a remaining portion excluding the central portion 2a is regarded as a “peripheral portion 2b”. That is, the cross-section of the secondary particles 2 includes the central portion 2a and the peripheral portion 2b. The peripheral portion 2b surrounds the central portion 2a.

The central portion 2a includes a plurality of first primary particles 1a having a first average particle diameter. The central portion 2a may include the first primary particles 1a. d1 indicates the first average particle diameter of the first primary particles 1a. d1 may be, for example, 100 nm or more, 120 nm or more, 140 nm or more, or 160 nm or more. d1 may be, for example, 200 nm or less or 180 nm or less. In the present specification, the average particle diameter of the primary particles may be an average value of the maximum Feret diameters. The “maximum Feret diameter” indicates a length of a long side of a minimum circumscribing rectangle (rectangle or square) of the particle. In a case where the minimum circumscribing rectangle is a square, the length of the long side indicates a length of one side. The maximum Feret diameter of the primary particles can be measured, for example, in a transmission electron microscopy (TEM) image. The average particle diameter of the first primary particles 1a indicates an arithmetic average of 10 first primary particles 1a. Here, a measurement region of the average particle diameter of the first primary particles 1a is a region inside a circular portion including the center of the minimum circumscribing circle of the secondary particles 2 and having a radius of 0.25D.

The peripheral portion 2b includes a plurality of second primary particles 1b having a second average particle diameter. The peripheral portion 2b may include the second primary particles 1b. d2 indicates the second average particle diameter of the second primary particles 1 b. d2 may be, for example, 80 nm or less, 60 nm or less, 50 nm or less, or 40 nm or less. d2 may be, for example, 10 nm or more, 20 nm or more, or 30 nm or more. The average particle diameter of the second primary particles 1b indicates an arithmetic average of 10 second primary particles 1b. Here, a measurement region of the average particle diameter of the second primary particles 1b is a remaining portion in the cross-section of the secondary particles 2 excluding a circular portion including the center of the minimum circumscribing circle of the secondary particles 2 and having a radius of 0.75D.

In the present embodiment, the relationship of d2<d1 is satisfied. That is, d1 d2 is more than 0 nm. By satisfying the relationship of d2<d1, it is expected to improve the rate characteristic while maintaining the energy density. d1−d2 may be, for example, 50 nm or more, 100 nm or more, or 120 nm or more. d1−d2 may be, for example, 200 nm or less, 180 nm or less, or 150 nm or less. In addition, for example, a relationship of d2≤50 nm and 100 nm≤d1 may be satisfied for d1 and d2.

The D50 of the secondary particles 2 may be, for example, 5 μm or more, 10 μm or more, 15 μm or more, or 20 μm or more. The D50 of the secondary particles 2 may be, for example, 50 μm or less, 45 μm or less, 40 μm or less, 35 μm or less, 30 μm or less, or 25 μm or less.

The fine pore volume of the secondary particles 2 may be, for example, 0.10 cm³/g or more, 0.11 cm³/g or more, 0.12 cm³/g or more, 0.13 cm³/g or more, 0.14 cm³/g or more, or 0.15 cm³/g or more. The fine pore volume of the secondary particles 2 may be, for example, 0.20 cm³/g or less, 0.19 cm³/g or less, 0.18 cm³/g or less, 0.17 cm³/g or less, 0.16 cm³/g or less, or 0.15 cm³/g or less. The fine pore volume of the secondary particles 2 can be measured by a Barrett-Joyner-Halenda (BJH) multi-point method.

Carbon may be attached to at least a part of a surface of the first primary particles 1a and the second primary particles 1b. The carbon may provide a carbon layer. Hereinafter, the “first primary particles 1a and the second primary particles 1b” may be abbreviated as “primary particles”. The attachment amount of the carbon may be, for example, 0.1% by mass or more, 0.5% by mass or more, 1% by mass or more, 2% by mass or more, 3% by mass or more, or 4% by mass or more with respect to the primary particles. The attachment amount of the carbon may be, for example, 5% by mass or less, 4% by mass or less, or 3% by mass or less with respect to the primary particles.

The primary particles include an olivine phosphate compound. The “olivine type” indicates a crystal structure belonging to a space group Pnma. The space group is identified by powder X-ray diffraction (X-ray diffraction, XRD) measurement. The primary particles may be, for example, a monophase compound. The primary particles may further include a phase belonging to another space group as long as the primary particles include an olivine-type crystal phase. The primary particles may further include, for example, an amorphous phase.

The olivine phosphate compound may include, for example, at least one selected from the group consisting of lithium iron phosphate (LFP), lithium manganese phosphate (LMP), and lithium iron manganese phosphate (LMFP). The olivine phosphate compound may have, for example, a composition represented by the following general formula.

LiₐMn₁₋ₓFeₓPO₄
For example, a relationship of “0.5≤a≤1.5” may be satisfied. x may be, for example, 0 or more, 0.05 or more, 0.1 or more, 0.2 or more, 0.3 or more, 0.4 or more, 0.5 or more, 0.6 or more, 0.7 or more, 0.8 or more, or 0.9 or more. x may be, for example, 1 or less, 0.9 or less, 0.8 or less, 0.7 or less, 0.6 or less, 0.5 or less, 0.4 or less, 0.3 or less, 0.2 or less, or 0.1 or less.

In the olivine phosphate compound, an element (dopant) other than Li, manganese (Mn), iron (Fe), phosphorus (P), and oxygen (O) may be doped. A doping amount (mass fraction of the mass with respect to the mass of Li) may be, for example, 0.01 to 0.1.

The olivine phosphate compound included in the first primary particles 1a and the second primary particles 1b may have the same composition or different compositions. For example, the first primary particles 1a and the second primary particles 1b may have different Mn ratios. In this case, the Mn content of the first primary particles 1a may be larger than the Mn content of the second primary particles 1b, or the reverse may be true.

The positive electrode active material may further include other components as long as the positive electrode active material includes the olivine phosphate compound. The other components may include, for example, a lithium nickel composite oxide (LNO), a lithium cobalt composite oxide (LCO), and a lithium manganese composite oxide (LMO). A mixing ratio (mass ratio) of the olivine phosphate compound to the other components may be, for example, “olivine phosphate compound/other components=9/1 to 1/9”. The mixing ratio (mass ratio) of the olivine phosphate compound to the other components may be, for example, “olivine phosphate compound/other components=8/2 to 2/8”. The mixing ratio (mass ratio) of the olivine phosphate compound to the other components may be, for example, “olivine phosphate compound/other components=7/3 to 3/7”. The mixing ratio (mass ratio) of the olivine phosphate compound to the other components may be, for example, “olivine phosphate compound/other components=6/4 to 4/6”. The positive electrode active material may be, for example, a mixture of a powder of the olivine phosphate compound and a powder of the other components.

The LNO may have, for example, a crystal structure belonging to a space group R-3m. The LNO may have, for example, a composition represented by the following general formula.

Li₁₋ₐNiₓM₁₋ₓO₂
In the formula, a relationship of −0.5≤a≤0.5 and 0≤x≤1 is satisfied. M may include, for example, at least one selected from the group consisting of Co, Mn, and Al.

The LNO may be represented by, for example, the following general formula. The compound represented by the following general formula may also be referred to as “NCM”.

Li₁₋ₐNiₓCo_{y}Mn_{z}O₂
In the formula, a relationship of −0.5≤a≤0.5, 0<x<1, 0<y<1, 0<z<1, and x+y+z=1 is satisfied.

The LNO may be represented by, for example, the following general formula. The compound represented by the following general formula may also be referred to as “NCA”.

Li₁₋ₐNiₓCo_{y}Al_{z}O₂
In the formula, a relationship of −0.5≤a≤0.5, 0<x<1, 0<y<1, 0<z<1, and x+y+z=1 is satisfied.

### Method for Producing Positive Electrode Active Material

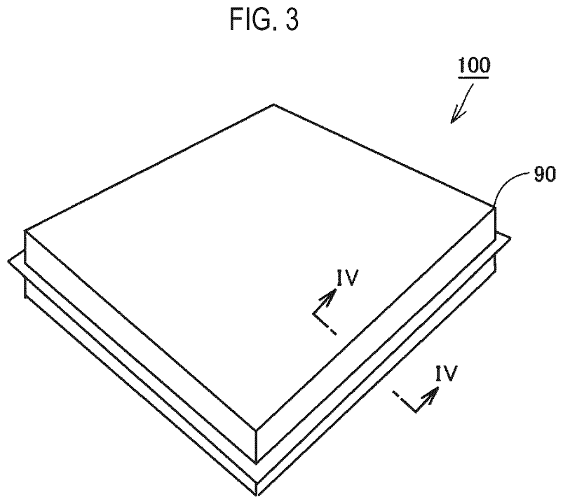

FIG. 2 is a schematic flowchart of a method for producing a positive electrode active material in the present embodiment. Hereinafter, the “method for producing a positive electrode active material in the present embodiment” may be abbreviated as “the present method”. The present method may include, for example, “(a) formation of slurry”, “(b) granulation”, and “(c) firing”.

### Formation of Slurry

The present method may include forming a slurry by mixing a lithium compound, a manganese compound, an iron compound, a phosphoric acid compound, and a solvent. For example, the lithium compound, the manganese compound, the phosphoric acid compound, and the iron compound may be weighed such that the composition ratio (mass ratio) is represented by a compositional formula “LiₐMn₁₋ₓFeₓPO₄ (0.5≤a≤1.5, 0≤x<1)”. The lithium compound may include, for example, lithium hydroxide. The manganese compound may include, for example, manganese carbonate. The phosphoric acid compound may include, for example, lithium dihydrogen phosphate. The iron compound may include, for example, ferric phosphate.

In a case where carbon is attached to a surface of the primary particles, a carbon source is added to the raw material mixture. The carbon source may include, for example, sugars, and organic acids. The carbon source may include, for example, glucose, sucrose, fructose, and citric acid. The addition amount of the carbon source may be, for example, 1% to 20% by mass with respect to the raw material mixture.

The solvent may include, for example, water. A concentration of solid contents of the slurry may be, for example, 20% to 40% by mass.

The particle size in the slurry may be adjusted by performing wet pulverization. For example, the wet pulverization may be performed such that the D50 is 0.10 μm to 1 μm.

### Granulation

The present method may include granulating the secondary particles (precursor) by drying the slurry. For example, the secondary particles may be granulated by a spray drying method. There may be two or more types of slurries, and for example, slurries having different particle sizes or concentrations of solid contents may be used. The secondary particles provided by the granulation operation are also referred to as “granulation bodies”. That is, the secondary particles may be referred to as granulation bodies. The spray drying may be performed two or more times. For example, the central portion of the granulation body may be provided by the first spray drying, and the peripheral portion of the granulation body may be provided by the second spray drying. In this case, by using the slurries having different particle sizes, the granulation bodies having different average particle diameters in the central portion and the peripheral portion can be provided.

The size of the secondary particles tends to change, for example, depending on a gas-liquid ratio of an atomizing gas and the slurry during the spray drying. For example, the secondary particles tend to be smaller as the nozzle pressure is higher.

### Firing

The present method may include producing an olivine phosphate compound by performing a heat treatment on the secondary particles (precursor). Any heat treatment furnace (for example, an electric furnace and a muffle furnace) can be used. The heat treatment atmosphere may be, for example, a nitrogen atmosphere. The heat treatment temperature may be, for example, 400° C. to 700° C. The heat treatment time may be, for example, 4 to 6 hours. In a case where the spray drying is performed two or more times in the granulation step, the firing step may be performed for each spray drying.

### Battery

In some of the present embodiments, the battery has a monopolar structure. In some of the present embodiments, the battery has a bipolar structure. As an example, a battery (bipolar battery) having a bipolar structure will be described.

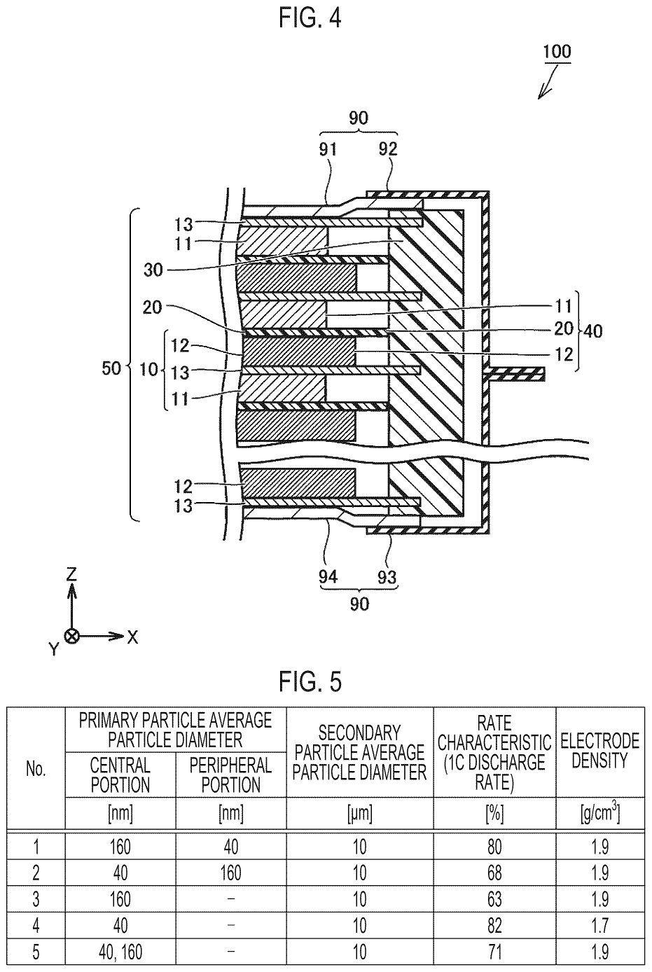

FIG. 3 is a schematic perspective view of a battery in the present embodiment. FIG. 4 is a schematic cross-sectional view taken along line IV-IV in FIG. 3. Hereinafter, the “normal direction” indicates a normal direction with respect to a surface of a sheet-like member (for example, a foil and an electrode). The “in-plane direction” indicates any direction orthogonal to the normal direction. In the drawings of the present embodiment, the Z-axis direction corresponds to the normal direction. The X-axis direction and the Y-axis direction are examples of the in-plane direction.

The battery 100 includes an exterior body 90 and a power generation element 50. The exterior body 90 accommodates the power generation element 50. The exterior body 90 may include, for example, a first collector plate 91, a first laminated film 92, a second laminated film 93, and a second collector plate 94. The first laminated film 92 and the second laminated film 93 are joined to each other at end parts in the in-plane direction. In the joint portion between the first laminated film 92 and the second laminated film 93, a sealing material (not shown) may be interposed between the first laminated film 92 and the second laminated film 93.

The first collector plate 91 and the second collector plate 94 are joined to the power generation element 50 at end parts in the stacking direction (Z-axis direction). The first laminated film 92 is joined to the first collector plate 91. The second laminated film 93 is joined to the second collector plate 94. In the joint portion between the collector plate and the laminated film, a sealing material (not shown) may be interposed between the collector plate and the laminated film.

The power generation element 50 includes a plurality of bipolar electrodes 10. The bipolar electrodes 10 are stacked in the normal direction (Z-axis direction). Each of the bipolar electrodes 10 includes a positive electrode layer 11, a collector foil 13, and a negative electrode layer 12 in this order in the normal direction. In the in-plane direction (for example, the X-axis direction), the collector foil 13 extends outward with respect to the positive electrode layer 11 and the negative electrode layer 12. For example, the collector foil 13 may extend outward with respect to the positive electrode layer 11 and the negative electrode layer 12 over the entire periphery in the in-plane direction.

The collector foil 13 is a conductor. The collector foil 13 may include, for example, a metal foil and a conductive resin layer. For example, the collector foil 13 may be provided by bonding an Al foil and a Cu foil. A carbon material may be applied to a surface of the collector foil 13. The carbon material may include, for example, carbon black.

The power generation element 50 includes a sealing material 30. The sealing material 30 is joined to the collector foil 13 at the end part in the in-plane direction. The sealing material 30 may be thermally welded to the collector foil 13, for example. For example, the sealing material 30 may be disposed over the entire periphery of the in-plane direction. The sealing material 30 may include, for example, a resin material. The sealing material 30 seals between the collector foils 13 adjacent to each other in the normal direction. The sealing material 30 seals between the collector foils 13 to partition a cell 40. The cell 40 is a minimum unit of the power generation element 50. Since the battery 100 includes a plurality of cells 40, the battery 100 may also be referred to as a “bipolar module”. Each of the cells 40 is sealed. The cells 40 are isolated from each other. Each of the cells 40 includes the positive electrode layer 11, the separator 20, the negative electrode layer 12, and an electrolytic solution.

### Positive Electrode Layer

The positive electrode layer 11 is attached to one surface of the collector foil 13. The positive electrode layer 11 includes a positive electrode active material. Details of the positive electrode active material are as described above.

The positive electrode layer 11 may further include, for example, a conductive material and a binder in addition to the positive electrode active material. A blending amount of the conductive material may be, for example, 0.1 to 10 parts by mass with respect to 100 parts by mass of the positive electrode active material. The conductive material may be, for example, acetylene black (AB). A blending amount of the binder may be, for example, 0.1 to 10 parts by mass with respect to 100 parts by mass of the positive electrode active material. The binder may be, for example, polyvinylidene fluoride (PVdF).

The positive electrode layer 11 may further include, for example, an inorganic filler, an organic filler, a solid electrolyte, a surface modifier, a dispersant, a lubricant, a flame retardant, a protector, a flux, a coupling agent, and an adsorbent.

From the viewpoint of increasing the energy density, an electrode density of the positive electrode layer 11 is 1.9 g/cm³ or more, and may be 2.0 g/cm³ or more. The electrode density of the positive electrode layer 11 may be, for example, 2.2 g/cm³ or less or 2.1 g/cm³ or less. The electrode density can be calculated from, for example, a cross-sectional SEM image of the positive electrode layer 11.

A basis weight of the positive electrode layer 11 may be 20 mg/cm² or more, 25 mg/cm² or more, or 28 mg/cm² or more. The basis weight of the positive electrode layer 11 may be, for example, 50 mg/cm² or less or 40 mg/cm² or less.

### Negative Electrode Layer

The negative electrode layer 12 is attached to one surface of the collector foil 13. The negative electrode layer 12 is disposed on a back side of the positive electrode layer 11. The negative electrode layer 12 may have a larger area than the positive electrode layer 11. The negative electrode layer 12 includes a negative electrode active material.

The negative electrode active material may include, for example, at least one selected from the group consisting of a carbon-based active material, an alloy-based active material, an Si—C composite material, a Li metal, a Li-based alloy, and lithium titanate.

The carbon-based active material may include, for example, at least one selected from the group consisting of graphite, soft carbon, and hard carbon. The “graphite” is a general term for natural graphite and artificial graphite. The graphite may be a mixture of natural graphite and artificial graphite.

The negative electrode layer 12 may further include, for example, a thickener and a binder in addition to the negative electrode active material. A blending amount of the thickener may be, for example, 0.1 to 10 parts by mass with respect to 100 parts by mass of the negative electrode active material. The thickener may be, for example, carboxymethyl cellulose (CMC). A blending amount of the binder may be, for example, 0.1 to 10 parts by mass with respect to 100 parts by mass of the negative electrode active material. The binder may be, for example, a styrene butadiene rubber (SBR).

### Separator

The separator 20 can separate the positive electrode layer 11 from the negative electrode layer 12. The separator 20 has electrical insulating properties. The separator 20 may include, for example, at least one selected from the group consisting of a resin film (polymer film), an inorganic particle layer, and an organic particle layer.

The resin film is porous. The resin film may include, for example, a microporous film and a nonwoven fabric. The resin film includes a resin skeleton. The resin skeleton may be, for example, continuously networked. Fine pores are provided in a gap of the resin skeleton. The resin film can transmit the electrolytic solution. The resin film may have, for example, an average fine pore diameter of 1 μm or less. The average fine pore diameter of the resin film may be, for example, 0.01 μm to 1 μm or 0.1 μm to 0.5 μm. The “average fine pore diameter” can be measured by a mercury pressure method. The Gurley value of the resin film may be, for example, 50 s/ 100 cm³ to 250 s/ 100 cm³. The “Gurley value” can be measured by a Gurley test method.

The resin film may be, for example, an olefin-based resin. The resin film may be, for example, polyethylene (PE) or polypropylene (PP). The thickness of the resin film may be, for example, 5 μm to 50 μm or 10 μm to 25 μm.

The resin film may have, for example, a monolayer structure. The resin film may include, for example, a PE layer. The skeleton of the PE layer is formed of PE. The PE layer may have a shutdown function. The resin film may have, for example, a multilayer structure. The resin film may include, for example, a PP layer and a PE layer. The skeleton of the PP layer is formed of PP. The resin film may have, for example, a three-layer structure. The resin film may be provided by laminating a PP layer, a PE layer, and a PP layer in this order, for example. The thickness of the PE layer may be, for example, 5 μm to 20 μm. The thickness of the PP layer may be, for example, 3 μm to 10 μm.

### Electrolytic Solution

The electrolytic solution is a liquid electrolyte. The electrolytic solution includes a solute and a solvent. A concentration of the solute may be, for example, 0.5 mol/L to 3 mol/L. The solute includes a supporting salt (Li salt). The solute may include, for example, an inorganic acid salt, an imide salt, an oxalato complex, and a halide.

The electrolytic solution may include, for example, a carbonate-based solvent (carbonate ester-based solvent). The solvent may be, for example, ethylene carbonate (EC), diethyl carbonate (DEC), or ethyl methyl carbonate (EMC).

The electrolytic solution may include any additive. An addition amount (mass fraction with respect to an entirety of the electrolytic solution) may be, for example, 0.01% to 5%, 0.05% to 3%, or 0.1% to 1%. The additive may include, for example, a solid electrolyte interphase (SEI) forming accelerator, an SEI forming inhibitor, a gas generator, an overcharge inhibitor, a flame retardant, an antioxidant, an electrode protector, and a surfactant. Examples of the additive include vinylene carbonate (VC).

The electrolytic solution may include an ionic liquid. The ionic liquid may include, for example, at least one selected from the group consisting of a sulfonium salt, an ammonium salt, a pyridinium salt, a piperidinium salt, a pyrrolidinium salt, a morpholinium salt, a phosphonium salt, an imidazolium salt, and derivatives thereof.

In some of the present embodiments, the battery may include a gel electrolyte. That is, the battery may be a polymer battery. The gel electrolyte may include an electrolytic solution and a polymer material. The polymer material may provide a polymer matrix. The polymer material may include at least one selected from the group consisting of PVdF, PVdF-HFP, polyacrylonitrile (PAN), PVdF-PAN, polyethylene oxide (PEO), polyethylene glycol (PEG), and derivatives thereof.

Hereinafter, the present disclosure will be described in more detail by embodiments, but the present disclosure is not limited to these examples.

### Production of Positive Electrode Active Material

The positive electrode active material (LMFP) according to No. 1 to No. 5 was produced according to the above-described production method. The positive electrode active material according to No. 1 to No. 5 includes the primary particles having an average particle diameter shown in FIG. 5. No. 3 is a positive electrode active material including secondary particles formed of only primary particles having an average particle diameter of 160 nm. No. 4 is a positive electrode active material including secondary particles formed of only primary particles having an average particle diameter of 40 nm. No. 5 is a positive electrode active material including secondary particles in which primary particles having an average particle diameter of 40 nm or 160 nm are randomly disposed.

### Manufacture of Evaluation Cell

A slurry was prepared by mixing LMFP as the positive electrode active material, AB as the conductive material, PVdF as the binder, and N-methylpyrrolidone (NMP) as the dispersion medium. The blending of the solid contents was set to “positive electrode active material/conductive material/binder=97.8/0.8/1.4 (mass ratio)”. The positive electrode layer was provided by applying the slurry to an Al foil (thickness: 30 μm). The positive electrode layer was dried. The positive electrode was produced by compressing the positive electrode layer. The positive electrode layer had an electrode density shown in FIG. 5.

A slurry was prepared by mixing graphite as the negative electrode active material, SBR as the binder, CMC as the thickener, and water as the dispersion medium. The blending of the solid contents was set to “negative electrode active material/thickener/binder=97/0.6/2.4 (mass ratio)”. The negative electrode layer was provided by applying the slurry to a Cu foil (thickness: 15 μm). The negative electrode layer was dried. The negative electrode was produced by compressing the negative electrode layer.

The following materials were prepared.
Separator: porous sheet made of PE
Electrolytic solution: LiPF₆ (concentration: 1.0 mol/L), EC+DEC+EMC
Exterior body: pouch made of Al laminated film

The power generation element was provided by laminating the positive electrode, the separator, and the negative electrode in this order. The evaluation cell was produced by sealing the power generation element and the electrolytic solution in the exterior body. The rated capacity of the evaluation cell was 150 mAh.

### 1C Discharge Rate

The rate of 0.1C and the rate of 1C were measured in a voltage range of 4.25 V to 3.0 V under a room temperature environment. “C” is a symbol representing the rate. At the rate of 1C, the rated capacity is discharged over 1 hour. A ratio (1C discharge capacity/0.1C discharge capacity) of the capacity (1C discharge capacity) at the time of 1C discharge to the capacity (0.1C discharge capacity) at the time of 0.1C discharge was calculated. It is considered that the higher the 1C discharge rate, the better the rate characteristic.

As shown in FIG. 5, in a case where the conditions of the present disclosure were satisfied, the rate characteristic tended to be improved while maintaining the electrode density (that is, the energy density). As shown in No. 3, in a case where the secondary particles include only primary particles having a large average particle diameter, the ion diffusibility tends to be poor. In addition, as shown in No. 4, in a case where the secondary particles include only primary particles having a small average particle diameter, the fine pore volume in the secondary particles increases, so that the positive electrode is likely to crack during compression in a case of producing the positive electrode, and the electrode density cannot be increased.

The embodiments and examples disclosed this time should be considered as illustrative in all aspects and not restrictive. The scope of the present disclosure is indicated by the scope of claims rather than by the above description, and is intended to include all modifications within the scope and meaning equivalent to the scope of the claims.

What is claimed is:

1. A positive electrode active material comprising a plurality of secondary particles, wherein:
a cross-section of each of the secondary particles includes a central portion and a peripheral portion;
the central portion includes a plurality of first primary particles having a first average particle diameter;
the peripheral portion includes a plurality of second primary particles having a second average particle diameter;
the first primary particles and the second primary particles contain an olivine phosphate compound;
a relationship of d2<d1 is satisfied;
d1 indicates the first average particle diameter; and
d2 indicates the second average particle diameter.

2. The positive electrode active material according to claim 1, wherein a relationship of d2≤50 nm and 100 nm≤d1 is satisfied.

3. The positive electrode active material according to claim 1, wherein:
D50 of the secondary particles is 5 μm or more; and
a fine pore volume of the secondary particles is 0.10 cm³/g or more and 0.15 cm³/g or less.

4. An electrode comprising a positive electrode layer, wherein:
the positive electrode layer contains the positive electrode active material according to claim 1; and
a basis weight of the positive electrode layer is 28 mg/cm² or more.

5. A battery comprising the electrode according to claim 4.
